(19) United States
(12) Patent Application Publication
(10) Pub. No.: US 2019/0302951 A1
(43) Pub. Date: Oct. 3, 2019

(54) METHODS AND SYSTEMS FOR DISPLAY DEVICE MULTIPLEXING AND DEMULTIPLEXING

(71) Applicant: Synaptics Incorporated, San Jose, CA (US)

(72) Inventors: Petr Shepelev, Campbell, CA (US); Joseph Kurth Reynolds, San Jose, CA (US)

(21) Appl. No.: 15/936,787

(22) Filed: Mar. 27, 2018

(51) Int. Cl. G06F 3/041; G06F 3/044; G02F 1/1333

(52) U.S. Cl. CPC G06F 3/0416; G06F 3/044; G06F 2203/04112; G02F 1/13338; G06F 3/0412

(57) ABSTRACT

A method may include determining a display control signal for a display pixel in a display device. The method may further include determining a capacitive sensing control signal that corresponds to a capacitive scan for a sensing region. The capacitive scan may detect a location of an input object in a sensing region using various sensing elements disposed in the display device. The method may further include generating a multiplexed signal that includes the display control signal and the capacitive sensing control signal. The multiplexed signal may cause, using a demultiplexer disposed in the display device, the display device to perform the capacitive scan and update the display pixel.

### FIELD

This disclosed technology generally relates to electronic devices and specifically to capacitive sensing matrix electrode arrays.

### BACKGROUND

Input devices, including proximity sensor devices (also commonly called touchpads or touch sensor devices), are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

Moreover, input devices may be integrated into display devices that both perform touch sensing and provide visual data. However, a finite number of traces can be disposed between a display panel and circuitry that operates the input device. Accordingly, many display devices are limited by the amount of hardware that can be placed inside the display panel, which can also communicate with components outside the display panel.

### SUMMARY

In general, in one aspect, the disclosed technology relates to an electronic system. The electronic system includes a display device that includes a demultiplexer, various display pixels, and various sensing elements. The electronic system further includes a processing system coupled to the display device. The processing system generates a multiplexed signal that includes a display control signal and a capacitive sensing control signal. The display device uses the demultiplexer and the multiplexed signal to perform a capacitive scan of a sensing region using the sensing elements and to update the display pixels.

In general, in one aspect, the disclosed technology relates to a processing system. The processing system includes a determination module that determines a display control signal for a display pixel in a display device. The determination module further determines a capacitive sensing control signal that corresponds to a capacitive scan for a sensing region. The capacitive scan detects a location of an input object in a sensing region using various sensing elements disposed in the display device. The processing system further includes a sensor module that includes sensor circuitry. The sensor module generates a multiplexed signal that includes the display control signal and the capacitive sensing control signal. The multiplexed signal causes, using a demultiplexer disposed in the display device, the display device to perform the capacitive scan and to update the display pixel.

In general, in one aspect, the disclosed technology relates to a method. The method includes determining a display control signal for a display pixel in a display device. The method further includes determining a capacitive sensing control signal that corresponds to a capacitive scan for a sensing region. The capacitive scan detects a location of an input object in a sensing region using various sensing elements disposed in the display device. The method further includes generating a multiplexed signal that includes the display control signal and the capacitive sensing control signal. The multiplexed signal causes, using a demultiplexer disposed in the display device, the display device to perform the capacitive scan and to update the display pixel.

Other aspects of the disclosed technology will be apparent from the following description and the appended claims.

### BRIEF DESCRIPTION OF DRAWINGS

FIG. 1 shows a block diagram of an example system that includes an input device in accordance with one or more embodiments.

FIG. 2 shows a schematic view of an electronic system in accordance with one or more embodiments.

FIG. 3A shows a schematic diagram of a demultiplexer in accordance with one or more embodiments.

FIG. 3B shows a timing diagram in accordance with one or more embodiments.

FIG. 4 shows a schematic view of an input device in accordance with one or more embodiments.

FIG. 5 shows a schematic view of a liquid crystal display device in accordance with one or more embodiments.

FIG. 6 shows a schematic view of an organic light emitting diode display device in accordance with one or more embodiments.

FIG. 7 shows a flowchart in accordance with one or more embodiments.

FIG. 8 shows a computing system in accordance with one or more embodiments.

### DETAILED DESCRIPTION

Specific embodiments of the disclosed technology will now be described in detail with reference to the accompanying figures. Like elements in the various figures may be denoted by like reference numerals and/or like names for consistency.

The following detailed description is merely exemplary in nature, and is not intended to limit the disclosed technology or the application and uses of the disclosed technology. Furthermore, there is no intention to be bound by any expressed or implied theory presented in the preceding technical field, background, brief summary or the following detailed description.

In the following detailed description of embodiments of the disclosed technology, numerous specific details are set forth in order to provide a more thorough understanding Of the disclosed technology. However, it will be apparent to one of ordinary skill in the art that the disclosed technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present disclosed technology provide input devices and methods that facilitate improved usability. In particular, one or more embodiments of the disclosed technology are directed to an electronic system that includes one or more demultiplexers embedded in a display device. For example, the display device may include a thin-film transistor matrix for implementing display pixels and sensing elements (e.g. touch sensors) for performing capacitive sensing. Thus, a demultiplexer may also correspond to various thin-film transistors within the display device.

Moreover, a processing system may embed display update information and capacitive sensing information within a multiplexed signal for transmission to the demultiplexer. Accordingly, the electronic system may use a single circuit connection, such as a common bus, for relaying the multiplexed signal to the demultiplexer. At the demultiplexer, the multiplexed signal may be subsequently converted into various control signals for various electrical components inside the display device, such as control signals for adjusting display pixels and performing capacitive scans using sensing elements. Likewise, the single circuit connection for the multiplexed signal may reduce the amount of circuit connections between the processing system and the display device, which may increase the number of electrical components available inside the display device.

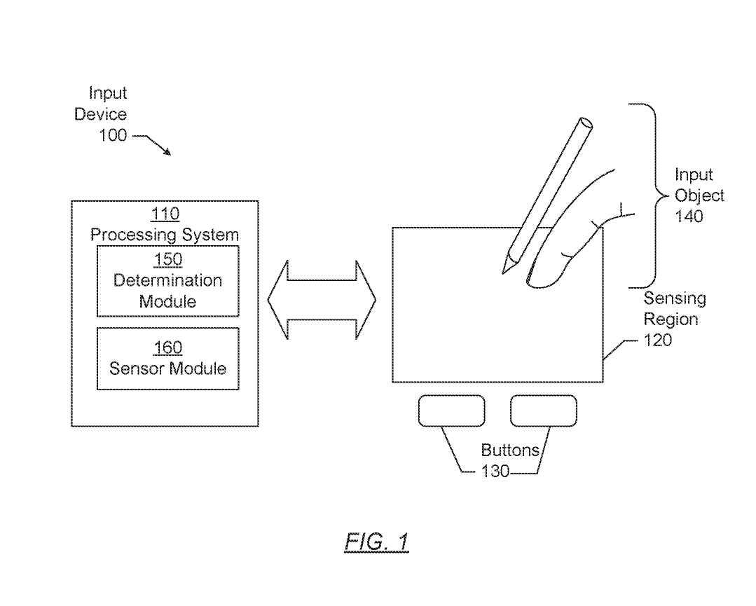

Turning now to the figures, FIG. 1 is a block diagram of an exemplary input device (100), in accordance with embodiments of this disclosed technology The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices (100), such as physical keyboards that include input device (100) and separate joysticks or key switches. Further example electronic systems include peripherals, such as data input devices (100) (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device (100).

The input device (100) may be implemented as a physical part of the electronic system, or may be physically separate from the electronic system. Further, portions of the input device (100) may be part of the electronic system. For example, all or part of the determination module (150) may be implemented in the device driver of the electronic system. As appropriate, the input device (100) may communicate with parts of the electronic system using any one or more of the following: buses, networks, and other wired or wireless interconnections. Example communication protocols include I2C, SPI, PS/2, Universal Serial Bus (USB), Bluetooth®, RF, and IrDA protocols.

In FIG. 1, the input device (100) is shown as a proximity sensor device (also often referred to as a “touchpad” or a “touch sensor device”) configured to sense input provided by one or more input objects (140) in a sensing region (120). Example input objects (140) include fingers and styli, as shown in FIG. 1. Throughout the specification, the singular form of input object (140) may be used. Although the singular form is used, multiple input objects (140) may exist in the sensing region (120). Further, the particular input objects (140) in the sensing region (120) may change over the course of one or more gestures. To avoid unnecessarily complicating the description, the singular form of input object (140) is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions (120) may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device (100) may be referred to as the above surface sensing region (120). The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that includes no contact with any surfaces of the input device (100), contact with an input surface (e.g., a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) may include one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher-dimensional spaces. Some implementations are configured to provide projections of input along particular axes or planes. Further, some implementations may be configured to provide a combination of one or more images and one or more projections.

In some capacitive implementations of the input device (100), voltage or current is applied to create an electric field. Nearby input objects (140) cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object (140). In various embodiments, an input object (140) near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects (140). The reference voltage may be a substantially constant voltage or a varying voltage, and in various embodiments, the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object (140) near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter signals may be electrically applied to transmitter electrodes, where the transmitter signals may be relative to a reference voltage (e.g., system ground). Receiver sensor electrodes may be held substantially constant relative to the reference voltage to facilitate receipt of resulting signals. The reference voltage may be a substantially constant voltage and, in various embodiments, the reference voltage may be system ground. The transmitter electrodes may be electrically driven with respect to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects (140) and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of, or all of, one or more integrated circuits (ICs) and/or other circuitry components. For example, a processing system (110) for a mutual capacitance sensor device may include transmitter circuitry configured to transmit signals with transmitter sensor electrodes, and/or receiver circuitry configured to receive signals with receiver sensor electrodes. Further, a processing system (110) for an absolute capacitance sensor device may include driver circuitry configured to drive absolute capacitance signals onto sensor electrodes, and/or receiver circuitry configured to receive signals with those sensor electrodes. In one or more embodiments, a processing system (110) for a combined mutual arid absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators/mechanisms (not shown), etc.

The processing system (110) may be implemented as a set of modules that handle different functions of the processing system (110). Each module may include circuitry that is a part of the processing system (110), firmware, software, and/or a combination thereof. In various embodiments, different combinations of modules may be used. For example, as shown in FIG. 1, the processing system (110) may include a determination module (150) and a sensor module (160). The determination module (150) may include functionality to determine when at least one input object (140) is in a sensing region (120), determine signal to noise ratio, determine positional information of an input object (140), identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensor circuitry comprising driving circuitry and/or sensing circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Alternative or additional modules may exist in accordance with one or more embodiments. Such alternative or additional modules may correspond to distinct modules or sub-modules of one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system (110) as a whole may perform the operations of the various modules.

In some embodiments, the processing system (110) responds to user input (or lack of user input) in the sensing region (120) directly by causing one or more actions. Example actions include changing operation modes as well as graphical user interface (GUI) actions such as cursor movement, selection, menu navigation, haptic actuation, and other functions. In some embodiments, the processing system (110) provides information about the input (or lack of input) to some part of the electronic system (e.g., to a central processing system (110) of the electronic system that is separate from the processing system (110), if such a separate central processing system (110) exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system (110). These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, force sensors, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light-emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

It should be understood that while many embodiments are described in the context of a fully-functioning apparatus, the mechanisms of the various embodiments are capable of being distributed as a program product (e.g., software) in a variety of forms. For example, the mechanisms of various embodiments may be implemented and distributed as a software program on information-bearing media that are readable by electronic processors (e.g., non-transitory computer-readable and/or recordable/writable information bearing media that is readable by the processing system (110)). Additionally, the embodiments may apply equally regardless of the particular type of medium used to carry out the distribution. For example, software instructions in the form of computer readable program code to perform one or more embodiments may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system (110), the input device (100), and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments may be implemented on a distributed system having several nodes, where each portion an embodiment may be located on a different node within the distributed system. In one or more embodiments, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the disclosed technology. For example, various components may be combined to create a single component. As another example, the functionality performed by a single component may be performed by two or more components. Accordingly, for at least the above-recited reasons, embodiments of the disclosed technology should not be considered limited to the specific arrangements of components and/or elements shown in FIG. 1.

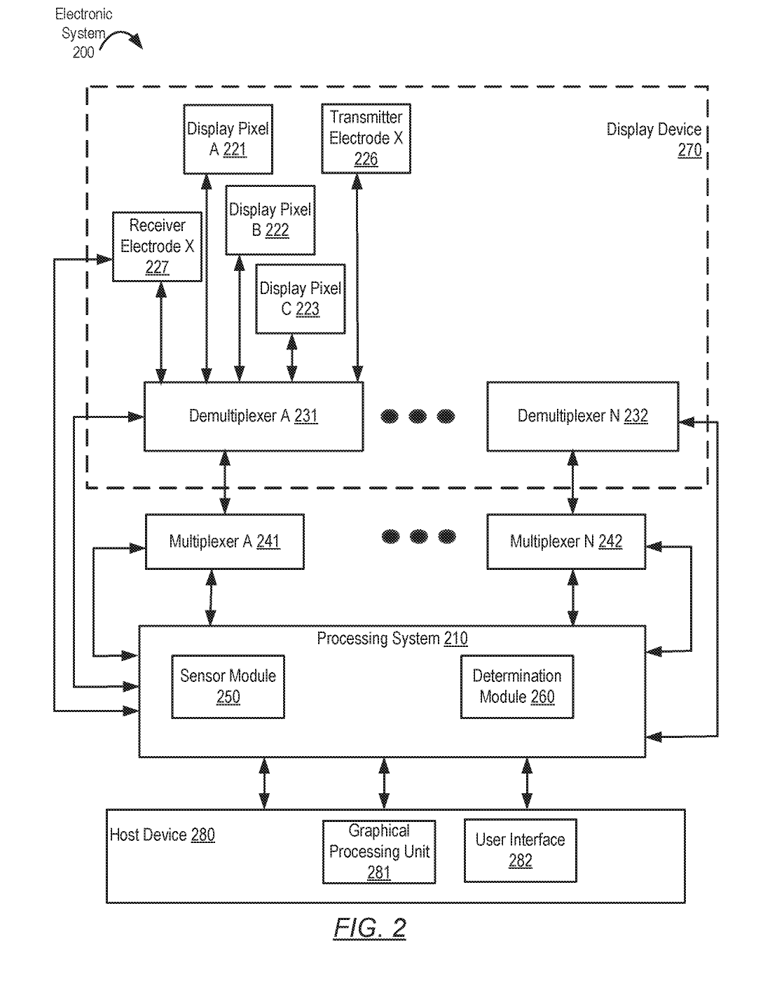

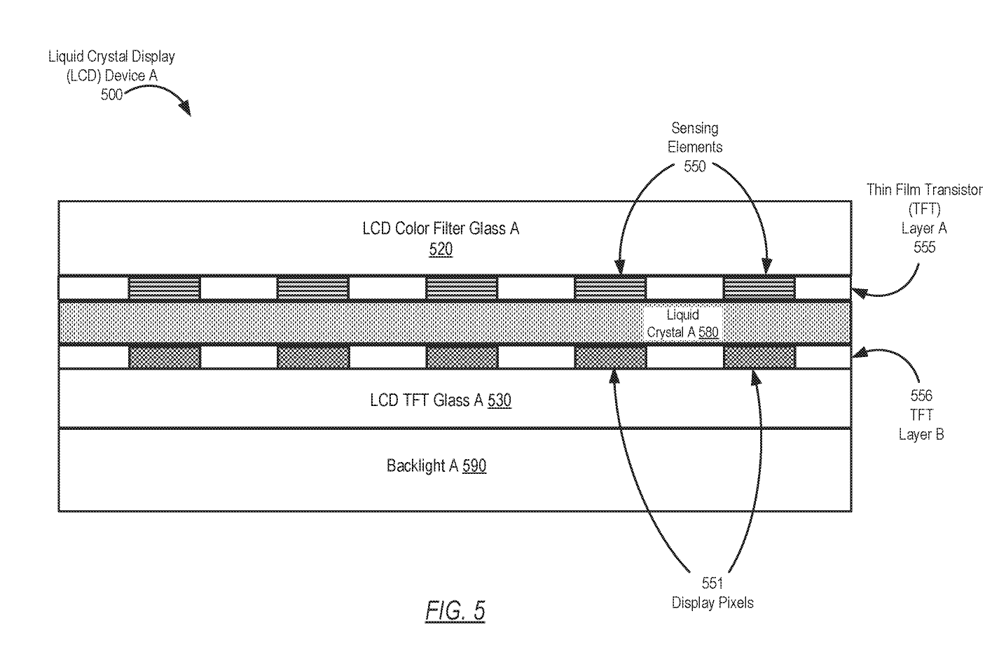

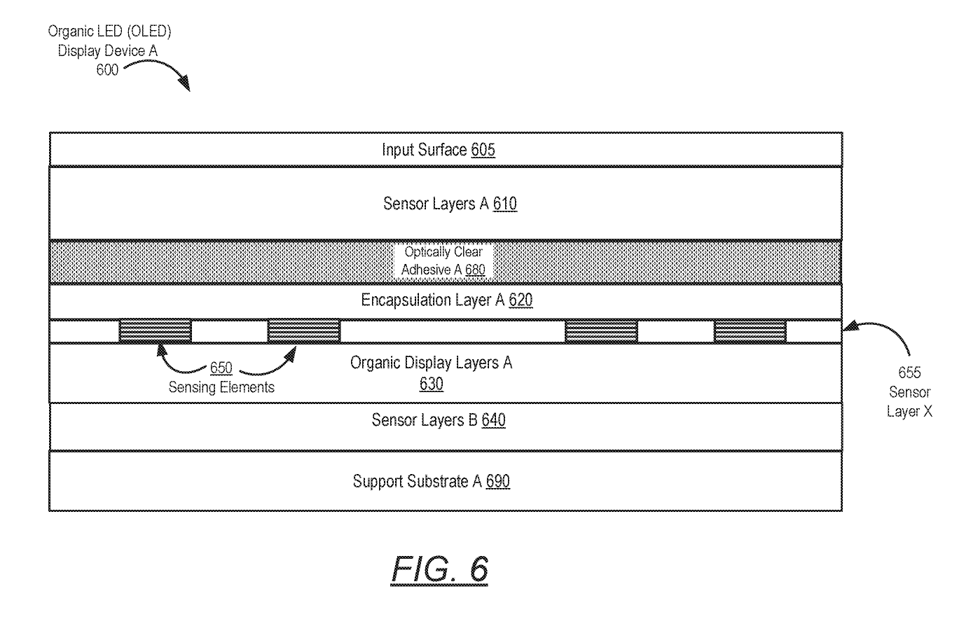

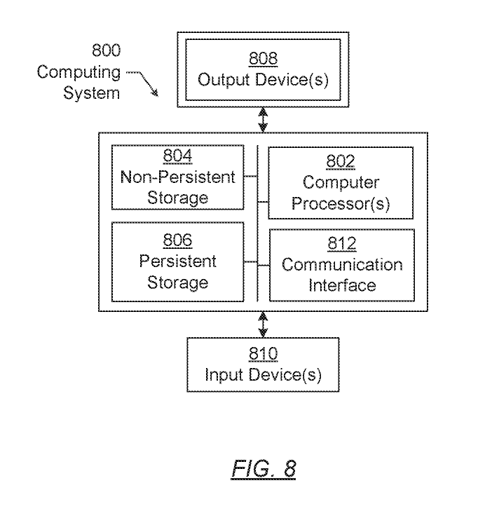

Turning to FIG. 2, FIG. 2 shows a schematic view of an electronic system (200) in accordance with one or more embodiments. As shown in FIG. 2, the electronic system (200) may include a processing system (210), a host device (280), and a display device (270). The display device (270) may include a display panel, and/or one or more display layers within the electronic system (200). In particular, the display device (270) may be a display area that includes hardware and/or software for generating and/or updating visual data displayed by the electronic system (200). For more information on display layers and/or the display device (270), see FIGS. 5 and 6 below and the accompanying description. The processing system (210) may include a sensor module (250) and a determination module (260). The sensor module (250) may be similar to the sensor module (160) described in FIG. 1 and the accompanying description. The determination module (260) may be similar to the determination module (150) described in FIG. 1 and the accompanying description. Likewise, the processing system (210) may be similar to processing system (110) described in FIG. 1 and the accompanying description and/or the computing system (800) described in FIG. 8 and the accompanying description. The host device (280) may also be a computing system similar to the computing system (800) described in FIG. 8 and the accompanying description.

Furthermore, the host device (280) may include a graphical processing unit (GPU) (281) and a user interface (282). A GPU may include hardware and/or software configured to determine and/or adjust visual data displayed by one or more display pixels (e.g., display pixel A (221), display pixel B (222), display pixel C (223)) in the display device (270). A display pixel may correspond to a particular colored sub-pixel (e.g. Red, Green, Blue, Yellow, White, etc.) that forms a portion of a pixel within a display panel. The GPU (281) may be operatively connected to the processing system (210) and may include functionality for transmitting display update commands to the processing system (210) and the display device (270). In particular, the display update commands may correspond to an image frame buffer managed by the GPU (281). Based on one or more user inputs obtained by the user interface (282), for example, the GPU (281) may include functionality for transmitting one or more display update commands to the processing system (210) that correspond to changes in pixel values among one or more display pixels in the display device (270). Likewise, the host device (280) may obtain positional information and/or object information describing one or more input objects in a sensing region from the processing system (210).

Moreover, the electronic system (200) may include various sensing elements (e.g., transmitter electrode X (226), receiver electrode X (227)). The sensing elements may be connected with thin-film transistors (TFT) located within an organic light-emitting diode (OLED) display device or a liquid crystal display (LCD). In another embodiment, the sensing element may be part of a sensor layer disposed between various display layers of a display device. Moreover, a sensing element may include various types of thin-film semiconductors, such as diodes, transistors, various electrode configurations, other semiconductor devices with two or more terminals, etc. In some embodiments, the sensing elements are sensor electrodes disposed in the display device (270), such as transmitter electrodes similar to the transmitter electrodes described in FIG. 1 and the accompanying description and/or receiver electrodes similar to the receiver electrodes described in FIG. 1 and the accompanying description.

In one or more embodiments, the electronic system (200) includes one or more multiplexers (e.g., multiplexer A (241), multiplexer N (242)) coupled to the processing system (210). In particular, a multiplexer may include hardware and/or software for generating a multiplexed signal from one or more control signals Obtained from the processing system (210) and/or other circuitry in the electronic system (200). In some embodiments, the multiplexers (241., 242) are disposed inside the processing system (210).

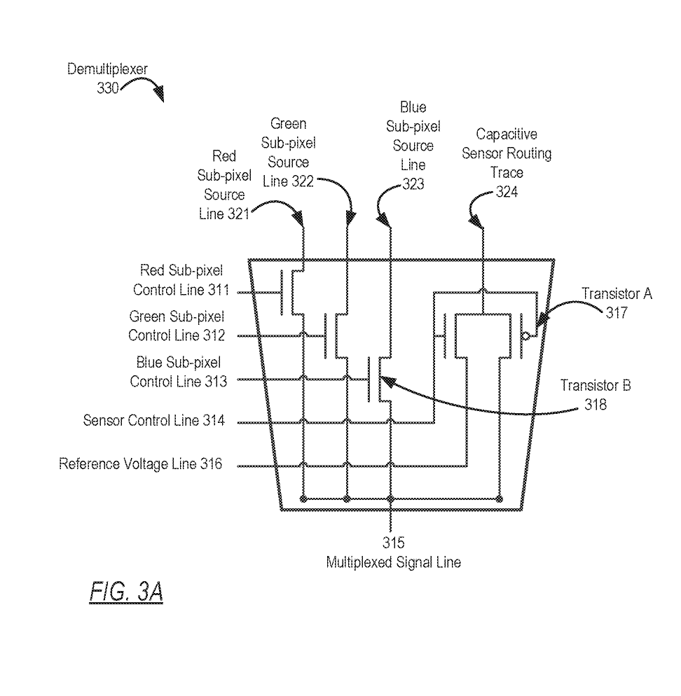

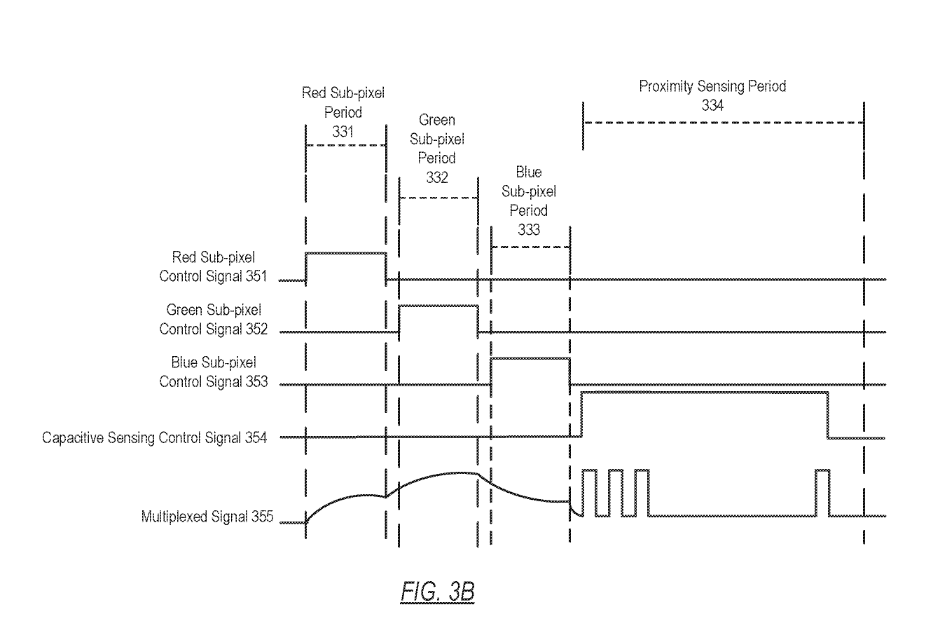

Furthermore, a multiplexed signal may correspond to one or more display control signals for operating display pixels and/or one or more capacitive sensing control signals for performing capacitive scans. In some embodiments, for example, a multiplexed signal is a voltage signal that includes a frame that defines various respective periods associated with display updating and/or capacitive sensing. In particular, periods within the multiplexed signal may correspond to updates for display pixels and modulated waveforms for proximity sensing. For more information on periods within a multiplexed signal, see FIG. 3B below and the accompanying description.

In one or more embodiments, the multiplexed signal may be transmitted to a demultiplexer (e.g., demultiplexer A (231), demultiplexer N (232)) that is disposed in the display device (270). As such, a demultiplexer may transform the multiplexed signal into respective control signals for adjusting display pixels and/or operating sensing elements (e.g., transmitter electrode X (226), receiver electrode X (227)). In some embodiments, a demultiplexer receives a multiplexed signal only for display updates, i.e., only corresponding to display control signals. For example, a display device may include one set of demultiplexers for display updates and another set of demultiplexers for capacitive sensing signals.

In some embodiments, for example, a demultiplexer is implemented using thin film transistors within a display device. For example, the demultiplexers (231, 232) may form a portion of a gate-in-panel (GIP) TFT matrix.

Turning to FIG. 3A, FIG. 3A shows a schematic view of a demultiplexer (330) in accordance with one or more embodiments. As shown in FIG. 3A, the demultiplexer (330) may include a multiplexed signal line (315) that obtains a multiplexed signal from a processing system (not shown). The multiplexed signal may then be transformed into various electrical control signals within the demultiplexer (330). In particular, the electrical control signals are outputted from the demultiplexer (330) over various traces (e.g., a display update control signal over a red sub-pixel source line (321), a display update control signal over a green sub-pixel source line (322), a display update control signal over a blue sub-pixel source line (323), and/or a sensing signal over a capacitive sensor routing trace (324)). As shown in FIG. 3A, the demultiplexer (330) may include various transistors (e.g., transistor A (317), transistor B (318)) that may include PMOS-type, NMOS-type and/or other types of transistors that may deviate from the exemplary embodiment illustrated in FIG. 3A. While FIG. 3A illustrates a demultiplexer for multiplexed signals corresponding to both display updates and capacitive sensing signals, other embodiments are contemplated where a demultiplexer is directed to only multiplexed signals for display control signals or only multiplexed signals for capacitive sensing control signals.

Likewise, a processing system and/or a host device may operate the demultiplexer (330) using various electrical control lines (e.g., red sub-pixel control line (311), green sub-pixel control line (312), blue sub-pixel control line (313), a capacitive sensor control line (314), and a reference voltage line (316)). Thus, the demultiplexer (330) may allow the processing system to couple with display pixels and/or sensing elements with no additional circuit connections to a TFT matrix inside a display device. That is the demultiplexer (330) may be controlled by the various electrical controls lines (311-314, 316) to connect the respective voltage outputs (e.g. source lines (321-323) or capacitive sensor routing trace (324) to the multiplexed signal line (315) or to the reference voltage line (316).

Furthermore, the reference voltage line (316) may designate a common voltage level for defining updates for various display pixels. For example, the reference voltage line (316) may correspond to a VCOM DC level in a liquid crystal display device or a Cathode DC level in an OLED display device.

Turning to FIG. 3B, FIG. 3B shows a timing diagram for various input signals and output signals of a demultiplexer in accordance with one or more embodiments. Specifically, a multiplexed signal (355) may be divided into various periods (e.g., a red sub-pixel period (331), a green sub-pixel period (332), a blue sub-pixel period (333), and a proximity sensing period (334)) within a sequence. For a respective period within the multiplexed signal (355), a display update may exist for a respective display pixel within a display device (e.g., the red sub-pixel period (331) corresponds to a display update of the red sub-pixel source line (321) using the red sub-pixel control signal (351), the green sub-pixel period (332) corresponds to a display update in the green sub-pixel source line (322) by control signal (352), and the blue sub-pixel period (333) corresponds to a display update in the blue sub-pixel source line (323) by control signal (353)). Thus, a demultiplexer may convert the multiplexed signal (355) on a multiplexed signal line (315) into various electrical signals (e.g., red sub-pixel control signal (351), green sub-pixel control signal (352), and the blue sub-pixel control signal (353)) for operating the respective display pixels lines (321-323). These control signals and signal periods may be for a particular vertical row of the display device, and may drive the source line update for sequential rows on following repeated periods, while the pixel row update may be selected by standard GIP row select electronics (e.g. a shift register).

Moreover, the proximity sensing period (334) of the multiplexed signal (355) may correspond to one or more sensing signals for performing a capacitive scan of a sensing region. As shown in FIG. 3B, the capacitive sensing control signal (354) may select the multiplexed signal line (315) to include a series of bursts from the multiplexed signal (355) for operating one or more sensor electrodes for detecting object information associated with one or more input objects within a sensing region connected to capacitive sensor routing trace (324) during the sensing period (334). Moreover, while the capacitive sensing control signal (354) may correspond to selecting a modulated waveform that defines various modulated amplitudes for sensing signals and/or guarding signals transmitted over various sensing elements during the sensing period (334), during the remaining time periods (e.g. 331-333) it may instead select the reference voltage line (316) voltage to be driven onto the routing trace (324). In some embodiments, the capacitive sensing control signal is for an input device implemented using segmented common electrodes in the display device, e.g., for absolute capacitive sensing an transcapacitive sensing.

Returning to FIG. 2, the processing system (210) may be mounted on a display layer, e.g., a chip on glass (COG) substrate for an LCD device. As such, the processing system (210) may have a similar output bump map as the demultiplexers (231, 232). Thus, the processing system (210) may have the same connections on a display substrate from a thin-film transistor to display driver circuitry (not shown) that may support In-Cell proximity sensing. Likewise, using a demultiplexer to implement a single circuit connection may unify the output connections for simpler processing system design. In some embodiments, a demultiplexer and a multiplexer are coupled using a common bus to implement the single circuit connection. Moreover, implementing demultiplexers within the display device (270) may substantially reduce a number of processing system connections to a transistor matrix within the display device (270), and hence may allow a larger pitch for respective substrate bumps for processing system connections (e.g. the number or connections may be reduced by hundreds of bumps).

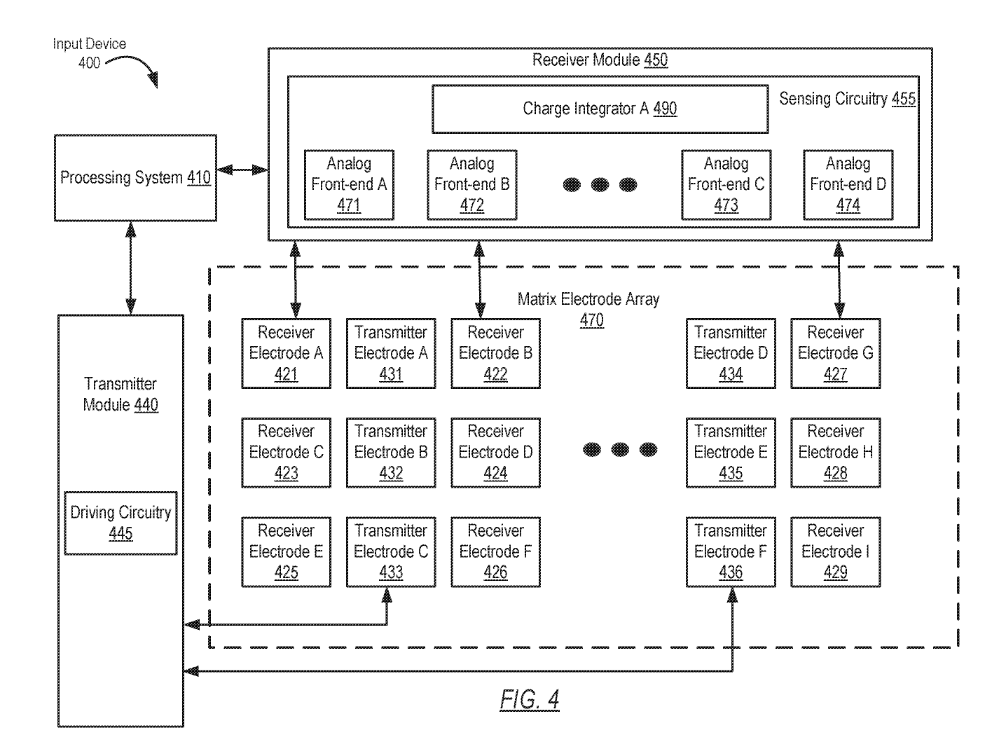

Turning to FIG. 4, FIG. 4 shows a schematic view of an input device (400) in accordance with one or more embodiments. As shown in FIG. 4, the input device (400) may include a receiver module (450), a transmitter module (440), and a processing system (410). In some embodiments, the input device (400) is a portion of the electronic system (200) described above in FIG. 2 and the accompanying description. For example, the processing system (410) may be similar to processing systems (110, 210) described above in FIGS. 1 and 2, and the accompanying description. The transmitter module (440) may include driving circuitry (445) that may be similar to transmitter circuitry described in FIG. 1 and the accompanying description. For example, driving circuitry (445) may include hardware and/or software that includes functionality to generate one or more sensing signals transmitted over one or more transmitter electrodes (e.g., transmitter electrode A (431), transmitter electrode B (432), transmitter electrode C (433), transmitter electrode D (434), transmitter electrode E (435), transmitter electrode F (436)). The transmitter electrodes (431, 432, 433, 434, 435, 436) may be similar to the transmitter electrodes described in FIG. 1 and the accompanying description. Likewise, various routing traces (not shown), such as GIP shift register lines, gate lines and source lines, may couple driving circuitry (445) with the transmitter electrodes (431, 432, 433, 434, 435, 436).

Moreover, the receiver module (450) may include sensing circuitry (455). For example, sensing circuitry (455) may include hardware and/or software that includes functionality to obtain one or more resulting signals from one or more receiver electrodes (e.g., receiver electrode A (421), receiver electrode B (422), receiver electrode C (423), receiver electrode D (424), receiver electrode E (425), receiver electrode F (426), receiver electrode G (427), receiver electrode H (428), receiver electrode I (429)) in response to one or more sensing signals transmitted over the transmitter electrodes (431, 432, 433, 434, 435, 436). The sensing circuitry (455) may be similar to the receiver circuitry described in FIG. 1 and the accompanying description.

In particular, the sensing circuitry (455) may include various analog front-ends (e.g., analog front-end A (471), analog front-end B (472), analog front-end C (473), analog front-end D (474)), which may include various analog conditioning circuitry. For example, analog-front ends may include operational amplifiers, digital-signal processing components, charge collection mechanisms, filters, and various application-specific integrated circuits for detecting and analyzing resulting signals obtained from the receiver electrodes (421, 422, 423, 424, 425, 426, 427, 428, 429). Likewise, the receiver electrodes (421, 422, 423, 424, 425, 426, 427, 428, 429) may be similar to the receiver electrodes described in FIG. 1 and the accompanying description. Various routing traces (not shown) may couple sensing circuitry (455) with the receiver electrodes (421, 422, 423, 424, 425, 426, 427, 428, 429).

In one or more embodiments, the input device (400) includes a matrix electrode array (e.g., matrix electrode array (470)). For example, the matrix electrode array (470) may include various sensor electrodes, such as the transmitter electrodes (431, 432, 433, 434, 435, 436) and the receiver electrodes (421, 422, 423, 424, 425, 426, 427, 428, 429). Likewise, sensor electrodes in a matrix electrode array may be disposed according to a predetermined shape, such as a square, rectangle, circle, regular and irregular shapes, and/or other geometric shapes.

Keeping with FIG. 4, in one or more embodiments, transmitter electrodes and/or routing traces are configured based on various types of analog front-ends. For example, in one type of analog front-end, the analog front-end may include and/or be coupled with a charge integrator. In another type of analog front-end, the analog front-end may be configured to operate using a current conveyor. Accordingly, an analog front-end may include an input terminal and a reference terminal. The input terminal may receive a resulting signal from a receiver electrode, while the reference terminal may be set to a DC voltage or a modulated voltage.

Moreover, various modes may be implemented with a particular Analog Front-End (i.e. AFE). In one mode, where a DC voltage is used at the reference terminal, sensing signals transmitted to transmitter electrodes may be modulated. Likewise, gate lines may be set to one or more DC voltage levels, while source lines may be set to one or more DC voltage levels or a high impedance (HiZ) level. In another mode, where a modulated signal is applied to the reference terminal, transmitter electrodes may be set at one or more DC voltage levels. As such, the gate lines may be guarded with a modulation signal with a similar waveform as the modulated signal applied to the reference terminal. The source lines may be similarly guarded in the manner as the gate lines or set to a HiZ level. In a further mode where a modulated signal is applied to the reference terminal of the AFE, each of the transmitter electrodes, source lines, and gate lines are modulated with a guard signal or allowed to float at high impedance to reduce the effect of panel coupling capacitance on the sensor while maintaining display voltages to minimize any visible effect. The different modes of an analog front-end may be implemented with respect to transmitter electrodes for capacitive sensing as well as sensor electrodes used for display updating.

The sensing circuitry (455) may include one or more charge integrators (e.g., charge integrator A (490)). In particular, a charge integrator may include hardware and/or software that includes functionality for transforming one or more resulting signals into a voltage output proportional a respective resulting signal. For example, a charge integrator may include an amplifier with an input terminal and a reference terminal that is configured in a similar manner as described above with respect to the input terminal and reference terminal of the analog front-end. Thus, charge integrator A (490) may include one or more amplifiers, various feedback capacitors, and other circuit components.

The sensing circuitry (455) may further include one or more current conveyors. For example, a current conveyor may include hardware and/or software for replicating a resulting signal and/or an approximation of a resulting signal. A current conveyor may also be configured according to one or more modes describes above with respect to the various types of analog front-ends.

Turning to FIG. 5, FIG. 5 shows a schematic view of an LCD device A (500) in accordance with one or more embodiments. As shown in FIG. 5, the LCD device A (500) may include various display layers (e.g., an LCD Color Filter Glass A (520), an LCD TFT Glass A (530)), a TFT layer A (555) including various sensing elements (550), a TFT layer B (556) including various display pixels (551), and a backlight A (590). In particular, one or more TFT layers may correspond to a TFT matrix within the LCD display device A (500). For example, the display pixels (551) may be thin-film transistors that include functionality to produce a voltage across liquid crystal (e.g., liquid crystal A (580)) that controls the polarization of light transmitted through the liquid crystal, and thus, the color of light exiting from an LCD color filter glass (e.g., LCD color filter glass A (520)). In some embodiments, the display pixels (551) are color sub-pixels that define a larger display pixel and are coupled to a demultiplexer. In some embodiments, the LCD device A (500) corresponds to the display device (270) described above in FIG. 2 and the accompanying description.

Furthermore, liquid crystal (e.g., liquid crystal A (580)) may be disposed between the LCD color filter glass A (520) and the TFT layer A (555) and/or TFT layer B (556). Liquid crystal may include various types of liquid crystal fluids such as thermotropic liquid crystals and/or lyotropic liquid crystals. An LCD color filter glass substrate (e.g., LCD color tiller glass A (520)) may be an approximately transparent substrate, e.g., glass, with a three-color pattern of red-green-blue (RGB) pixels disposed upon the transparent substrate. For example, the three-color pattern may be the product of a hardened photosensitive color resist coated on the glass substrate. A backlight and polarizer (e.g., backlight A (590)) may be a white light source, such as a fluorescent lamp or other lighting device that includes functionality to transmit visible light through an LCD device to produce light within a predetermined color spectrum with polarized light. While a backlight is shown in FIG. 5, in one or more embodiments, an LCD device may be implemented without a backlight (e.g. reflected light may be polarized). Likewise, while several display layers are shown in FIG. 5, an LCD device may include other display layers not shown (e.g. above the color filter), such as a reflector layer, a polarizer layer, a diffusing plate, various cathode and/or anode layers, a thin-film semiconductor layer for implementing an active-matrix LCD device, etc. This allows controlling the transmission of polarized light through the LCD pixels as an array of light valves.

Keeping with FIG. 5, the LCD device A (500) may include various sensing elements (550) with functionality to detect the presence of one or more input objects (not shown) in a sensing region (not shown) of the LCD device A (500). In one or more embodiments, the sensing elements (550) are thin-film transistors. In particular, various types of TFT structures may be employed that include various arrangements of electrodes. In various TFT structures, for example, a thin-film transistor may include a source electrode and a gate electrode disposed inside a semiconductor layer, above a semiconductor layer, or in a gate insulator coupled to the semiconductor layer. Likewise, the semiconductor layer of a thin-film transistor may include amorphous silicon, polysilicon, and/or other types of TFT semiconductor material (e.g. Indium Gallium Zinc Oxide). In another embodiment, for example, the sensing elements (550) are organic thin-film transistors that use an organic semiconductor in the thin-film transistor's channel. Likewise, transparent thin-film transistors may be used for the sensing elements (550). Moreover, the gate electrode of a thin-film transistor may be disposed inside a gate insulator or above the gate insulator.

Turning to FIG. 6, FIG. 6 shows a schematic view of an OLED display device A (600) in accordance with one or more embodiments. As shown in FIG. 6, the OLED display device A (600) may include various display layers (e.g., input surface (605), sensor layers A (610), sensor layers B (640), sensor layer X (655), an encapsulation layer A (620), organic display layers A (630), and a support substrate A (690)), such as glass. A display layer may be a substrate within a display device that is configured to perform functionality such as generating an output to a user (e.g., with respect to audio and/or visual outputs), obtaining an input from a user (e.g., detect proximity of an input object at the display device), and/or providing physical support for one or more components within the display device. A display layer, such as sensor layer X (655), may include various sensing elements (e.g., sensing elements (650)), such as transmitter electrodes, receiver electrodes, force sensors, thin-film transistors, diodes, etc. In some embodiments, a display layer may include a layer of display pixels that are coupled to a demultiplexer (not shown). Accordingly, one or more display layers may operate cooperatively to perform a particular function with respect to the display device. The OLED display device A (600) may be a white OLED, a foldable OLED, a transparent OLED, a passive-matrix or active-matrix OLED, a top-emitting OLED, or among various other types of OLED devices. In some embodiments, the OLED device A (600) corresponds to the display device (270) described above in FIG. 2 and the accompanying description.

Moreover, the OLED display device A (600) may include proximity-sensing functionality that detects the location of one or more input objects disposed in a sensing region. Likewise, sensor layers A (6110) and/or sensor layers B (640) may include sensor layers such as transmitter electrodes and/or receiver electrodes directly on the encapsulation layer (620) or on a separate substrate attached with optically clear adhesive (680). The transmitter electrodes and/or the receiver electrodes in the sensor layers (610, 640) may be similar to the transmitter electrodes and/or receiver electrodes described above in FIGS. 1 and 2, and the accompanying description.

In particular, the OLED display device A (600) may include various organic display layers (e.g., organic display layers A (630)) composed of organic molecules or polymers. The organic display layers A (630) may include functionality to generate visible light that presents visual data to a user. For example, the organic display layers A (630) may include an emissive layer and a conductive layer. Likewise, the OLED display device A (600) may also include various non-organic display layers (not shown) such as a cathode layer and/or an anode layer that include functionality for operating organic display layers. Moreover, intersections of a cathode layer and an anode layer may be arranged to form various display pixels within the OLED display device A (600). Likewise, different types of visible light may be generated by a particular pixel within the OLED display device A (600). Further, organic display layers may be disposed on a support substrate (e.g., support substrate A (690)) that may be flexible or rigid.

Keeping with FIG. 6, the OLED display device A (600) may include an encapsulation layer (e.g., encapsulation layer A (620)) that includes functionality to provide a barrier around various organic display layers (e.g., organic display layers A (630)). For example, the encapsulation layer A (620) may be a single layer or multiple layers disposed on, above, or below the organic display layers A (630). As such, the encapsulation layer A (620) may be a thin film that includes organic and/or inorganic chemical layers that protects various organic display layers from oxygen, water vapor, and/or other harmful substances to OLEDs.

In one or more embodiments, one or more display layers in the OLED display device A (600) may include various thin-film transistors that include functionality for detecting an input force (not shown) and/or the location of one or more input objects (not shown) in a sensing region. For example, sensing elements in the OLED display device A (600) may include thin-film transistors disposed below the encapsulation layer A (620) in an oxygen-protected region of the OLED display device A (600). For example, other TFT electrodes may exist in the protected region along with the sensing elements (650). The other TFT electrodes may include functionality to implement an active-matrix OLED device, for example, that controls image generation within the OLED display device A (600). While several types of display layers are shown in FIG. 6, an OLED display device may include other display layers not shown, such as an additional encapsulation layer, a buffer layer, a TFT backplane, etc.

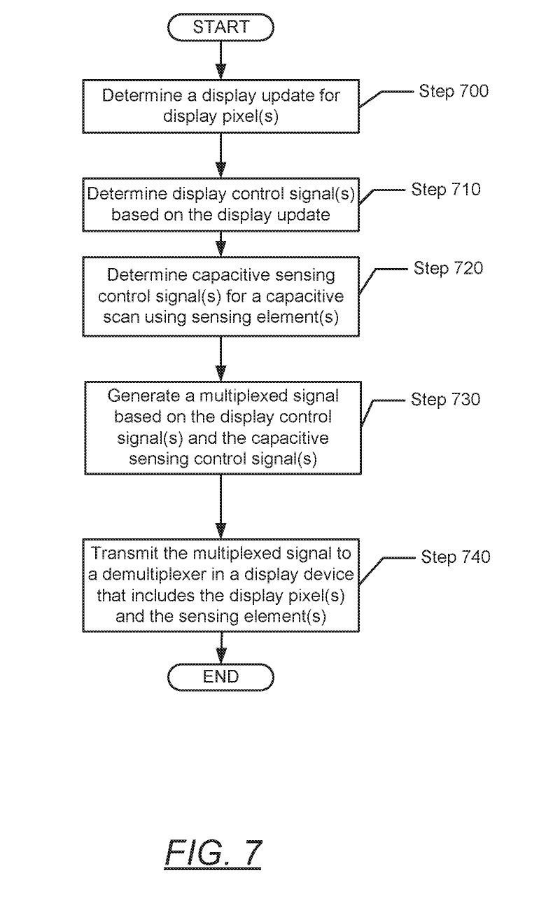

Turning to FIG. 7, FIG. 7 shows a flowchart in accordance with one or more embodiments. Specifically, FIG. 7 describes a method for performing display updates and/or capacitive sensing. The process shown in FIG. 7 may involve, for example, one or more components discussed above in reference to FIGS. 1, 2, 4, 5, and 6 (e.g., processing system (110)). While the various steps in FIG. 7 are presented and described sequentially, one of ordinary skill in the art will appreciate that some or all of the steps may be executed in different orders, may be combined or omitted, and some or all of the steps may be executed in parallel. Furthermore, the steps may be performed actively or passively and executed in combination with other appropriate display update and capacitive sensing requirements (e.g. GIP control, backlight control, power supply control, sensing modulation signal generation, etc.).

In Step 700, a display update is determined for one or more display pixels in accordance with one or more embodiments. For example, a graphical processing unit may determine a display update for adjusting one or more display pixels within a display device. The display update may include changing one or more pixels values for all or a portion of the display pixels, e.g., changing the color of a display pixel by manipulating sub-pixels, adjusting brightness levels, etc. Furthermore, the graphical processing unit may determine a display update based on one or more user inputs obtained by a user interface. In response to the input, a graphical processing unit may transmit one or more display updates to a processing system. In some embodiments, the processing system may determine a display update for a display device, e.g., based on object information regarding one or more input objects detected in a sensing region.

In Step 710, one or more display control signals are determined based on a display update in accordance with one or more embodiments. For example, a processing system may determine one or more display control signals for adjusting one or more display pixels in a display device. A display control signal may encode a brightness of a sub-pixel in an LCD device, an OLED device, and/or another type of display device. In some embodiments, the display control signals are similar to the red sub-pixel control signal (351), the green sub-pixel control signal (352), and the blue sub-pixel control signal (353) described in FIG. 3B and the accompanying description. Likewise, a display control signal may correspond to a particular source line coupled to a demultiplexer within a display device, e.g., source lines similar to the red sub-pixel source line (321), green sub-pixel source line (322), and/or blue sub-pixel source line (323) described in FIG. 3A and the accompanying description.

In Step 720, one or more capacitive sensing control signals are determined for a capacitive scan using one or more sensing elements in accordance with one or more embodiments. For example, a processing system may determine a capacitive scan for detecting and/or monitoring an input object in a sensing region. As such, the processing system may determine one or more capacitive sensing control signals for implementing the capacitive scan using sensing elements associated with an input device. In particular, a capacitive sensing control signal may correspond to one or more sensing signals transmitted along one or more sensor electrodes to perform a capacitive scan of a sensing region. Moreover, a capacitive sensing control signal may be similar to the capacitive sensing control signal (354) described above in FIG. 3B and the accompanying description.

In Step 730, a multiplexed signal is generated based on one or more display control signals and one or more capacitive sensing control signals in accordance with one or more embodiments. In some embodiments, a processing system uses a multiplexer to combine various display control signals and/or capacitive sensing control signals into one or more multiplexed signals. In one or more embodiments, the processing system directly generates the multiplexed signal without using an external multiplexer. As such, various control signals embedded in the multiplexed signal may be decoded inside a demultiplexer within a display device for operating display pixels and/or performing capacitive sensing with respect to a sensing region.

In Step 740, a multiplexed signal is transmitted to a demultiplexer in a display device that includes one or more display pixels and one or more sensing elements in accordance with one or more embodiments. In some embodiments, a demultiplexer is embedded within a thin-film transistor matrix within a display device. Thus, the multiplexed signal may be transmitted over a single circuit connection for input to the demultiplexer. Thus, the demultiplexer may determine various sensing element and display pixel states that may be relayed by the demultiplexer as control signals to the respective elements.

Embodiments may be implemented on a computing system (800). Any combination of mobile, desktop, server, router, switch, embedded device, or other types of hardware may be used. For example, as shown in FIG. 8, the computing system (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), and numerous other elements and functionalities.

The computer processor(s) (802) may be an integrated circuit for processing instructions. For example, the computer processor(s) (802) may be one or more cores or micro-cores of a processor. The computing system (800) may also include one or more input devices (810), such as a touchscreen, keyboard, mouse, microphone, touchpad, electronic pen, or any other type of input device (810).

The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the computing system (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing systems exist, and the aforementioned input and output device(s) may take other forms.

Software instructions in the form of computer readable program code to perform embodiments of the disclosed technology may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosed technology.

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the disclosed technology. The processes may be part of the same or different application and may execute on the same or different computing system.

Rather than or in addition to sharing data between processes, the computing system performing one or more embodiments of the disclosed technology may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosed technology, may extract one or more data items from the obtained data. For example, the extraction may be performed as follows by the computing system (800) in FIG. 8. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 8, while performing one or more embodiments of the disclosed technology, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosed technology, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 8 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The computing system of FIG. 8 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identities the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system (800). For example, data may be presented to a user using a vibration generated by a handheld computer device with a predefined duration and intensity of the vibration to communicate the data.

The above description of functions presents only a few examples of functions performed by the computing system (800) of FIG. 8. Other functions may be performed using one or more embodiments of the disclosed technology.

While the disclosed technology has been described with respect to a limited number of embodiments, those skilled in the art, having benefit of this disclosed technology, will appreciate that other embodiments can be devised which do not depart from the scope of the disclosed technology as disclosed herein. Accordingly, the scope of the disclosed technology should be limited only by the attached claims.

What is claimed is:

1. An electronic system comprising:
a display device comprising a demultiplexer, a plurality of display pixels, and a plurality of sensing elements; and
a processing system coupled to the display device,
wherein the processing system is configured to generate a multiplexed signal comprising a display control signal and a capacitive sensing control. signal, and
wherein the display device is configured to use the demultiplexer and the multiplexed signal to perform a capacitive scan of a sensing region using the plurality of sensing elements and to update one or more of the plurality of display pixels.

2. The electronic system of claim 1, further comprising:
a multiplexer coupled to the processing system and the demultiplexer in the display device,
wherein the multiplexer is configured to generate the multiplexed signal using the display control signal and the capacitive sensing control signal as inputs to the multiplexer.

3. The electronic system of claim 1,
wherein the demultiplexer is further configured to generate, based at least in part on the multiplexed signal, the display control signal, and
wherein the display signal is configured to adjust an amount of brightness of the one or more of the plurality of display pixels.

4. The electronic system of claim 1,
wherein the demultiplexer is further configured to generate, based at least in part on the multiplexed signal, the capacitive sensing control signal, and
wherein the display device is configured to transmit one or more sensing signals over at least one transmitter electrode among the plurality of sensing elements corresponding to the capacitive sensing control signal.

5. The electronic system of claim 1, further comprising:
a common bus coupled to the multiplexer and a portion of a display device comprising the plurality of sensing elements and the plurality of display pixels,
wherein the multiplexer is further configured to transmit the multiplexed signal over the common bus to the portion of the display device.

6. The electronic system of claim 1,
wherein the multiplexed signal is a voltage signal that comprises a plurality of a plurality of periods during a predetermined frame,
wherein the plurality of periods comprises a proximity sensing period for performing the capacitive scan, and
wherein the plurality of periods further comprises a plurality of display pixel periods for updating the plurality of display pixels.

7. The electronic system of claim 6,
wherein the multiplexed signal comprises a modulated waveform during the proximity sensing period that corresponds to a plurality of modulated amplitudes for one or more guarding signals that are transmitted over the plurality of sensing elements.

8. The electronic system of claim 1,
wherein the display device is an organic light emitting diode (OLED) display device, and
wherein the plurality of display pixels comprise a green sub-pixel, a red sub-pixel, and a blue sub-pixel of an active matrix of the OLED display device.

9. The electronic system of claim 1,
wherein the plurality of display pixels and the plurality of sensing elements correspond to a. plurality of thin film transistors (TFTs),
wherein the multiplexed signal is configured to apply a predetermined voltage to a plurality of source lines coupled to the plurality of TFTs to update the one or more of the plurality of display pixels and perform the capacitive scan.

10. The electronic system of claim 1,
wherein the plurality of sensing elements are at least a portion of a matrix electrode array,
wherein the plurality of sensing elements comprises a plurality of receiver electrodes and a plurality of transmitter electrodes,
wherein the multiplexed signal is configured to generate one or more sensing signals along the plurality of transmitter electrodes, and
wherein the processing system is configured to obtain one or more resulting signals from the plurality of receiver electrodes.

11. The electronic system of claim 1, further comprising:
a plurality of multiplexers coupled to the processing system,
wherein the plurality of multiplexers are configured to transmit a plurality of respective multiplexed signals to a plurality of respective regions of a display device.

12. The electronic system of claim 1, further comprising:
a host device coupled to the processing system, the host device comprising a graphical processing unit,
wherein the graphical processing unit is configured to transmit a display update command to the processing system, and
wherein the host device is configured to obtain, from the processing system, positional information regarding a location of one or more input objects in the sensing region in response to the capacitive scan of the sensing region.

13. The electronic system of claim 1,
wherein the display device is a display panel.

14. A processing system, comprising:
a determination module, the determination module configured to:
determine a display control signal for one or more display pixels in a display device, and
determine a capacitive sensing control signal that corresponds to a capacitive scan for a sensing region, wherein the capacitive scan is configured to detect a location of one or more input objects in a sensing region using a plurality of sensing elements disposed in the display device; and
a sensor module comprising sensor circuitry, the sensor module configured to:
generate a multiplexed signal comprising the display control signal and the capacitive sensing control signal,
wherein the multiplexed signal is configured to cause, using a demultiplexer disposed in the display device, the display device to perform the capacitive scan and to update the one or more display pixels.

15. The processing system of claim 14, wherein the sensor module is further configured to transmit the multiplexed signal to the demultiplexer in the display device.

16. The processing system of claim 14, further comprising:
a multiplexer,
wherein the multiplexer is configured to generate the multiplexed signal using the display control signal and the capacitive sensing control signal as inputs to the multiplexer.

17. The processing system of claim 14,
wherein the multiplexed signal is a voltage signal that comprises a plurality of a plurality of periods during a predetermined frame,
wherein the plurality of periods comprises a proximity sensing period for performing the capacitive scan, and
wherein the plurality of periods further comprises a plurality of display pixel periods for updating the plurality of display pixels.

18. The processing system of claim 14,
wherein the multiplexed signal comprises a modulated waveform during the proximity sensing period that corresponds to a plurality of modulated amplitudes for one or more guarding signals that are transmitted over the plurality of sensing elements.

19. A method, comprising:
determining a display control signal for one or more display pixels in a display device;
determining a capacitive sensing control signal that corresponds to a capacitive scan for a sensing region, wherein the capacitive scan detects a location of one or more input objects in a sensing region using a plurality of sensing elements disposed in the display device; and
generating a multiplexed signal comprising the display control signal and the capacitive sensing control signal,
wherein the multiplexed signal is configured to cause, using a demultiplexer disposed in the display device, the display device to perform the capacitive scan and to update the one or more display pixels.

20. The method of claim 19, further comprising:
transmitting the multiplexed signal to the demultiplexer in the display device.
